(19) United States
(12) Patent Application Publication
(10) Pub. No.: US 2002/0042773 A1
(43) Pub. Date: Apr. 11, 2002

(54) System and method for bill collection

(76) Inventors: James Roy Fugitte, Elizabethtown, KY (US); Priscilla Stricker Capes, Louisville, KY (US); David Chesterfield Broyles, Shepherdsville, KY (US); George Thomas Brumfield, Elizabethtown, KY (US); Joy Grace Green, Elizabethtown, KY (US); James Joshua Hartlage, Louisville, KY (US); John Edward Hynes, Louisville, KY (US); Leslie Gail Knight, Upton, KY (US); Janice Wortham Miller, Hodgenville, KY (US); Kimberly Denise Ramsey, Elizabethtown, KY (US); Karen Sue Welch, Elizabethtown, KY (US)

Correspondence Address: FROST BROWN TODD LLC, 2200 PNC Center, 201 E. Fifth Street, Cincinnati, OH, 45202-4182, US

(21) Appl. No.: 09/932,144

(22) Filed: Aug. 17, 2001

Related U.S. Application Data
(60) Provisional application No. 60/225,844, filed on Aug. 18, 2000.

(51) Int. Cl. G06F 17/60

(52) U.S. Cl. 705/39

(57) ABSTRACT

A system and method of electronic payment collection is disclosed.

### BACKGROUND OF THE INVENTION

1. Field of the Invention

The field of invention relates generally to electronic systems and methods for bill collection.

2. Description of the Related Art

In general, when a Creditor wishes to collect money from a Debtor, they must contact the Debtor, possibly a delinquent debtor, and request payment, perhaps by check. The Creditor must then wait a certain amount of time to receive the check and another length of time for the check to clear. If the Creditor takes payment over the phone by a different method, such as a credit card, the Creditor must engage in the time-consuming process of recording the Debtor's credit card information and then processing the transaction. The Debtor also experiences a great deal of uncertainty when a check is sent in or a credit card number is given out because, in the case of the check, the Debtor does not receive confirmation that the payment has been received and processed by the Creditor until the cancelled check is returned to them and, in the case of a credit card number, the Debtor does not receive confirmation of the payment until their next credit card statement. In addition, prudent Creditors frown on the practice of allowing a borrower to pay on a loan with another credit instrument, such as a credit card.

Another method of paying debts includes electronic funds transfer (EFT), which is managed by the Automated Clearing House (ACH) (http://www.fins.treas.gov/ach/index.html) and governed by the National Automated Clearing House Association Rules and Regulations (htt ://www.nacha.org). ACH is a privately operated network utilized to facilitate (EFT) within the financial community (http://www.fins.treas.gov/eft/index.html). To access ACH, however, an entity must be affiliated with or actually be a financial institution, such as a bank, because only such financial institutions have access to the Federal Reserve System. Therefore, ACH transactions are not always readily available to Creditors that are not affiliated with a bank. Electronic bill payments are used frequently by people, companies, and government agencies as a safe, reliable and convenient way to conduct business. This method of procuring payments will only become more popular due to the recently signed Electronic Signatures in Global and National Commerce Act (Public Law 106-229). Electronic payments encompass the areas of Internet commerce, electronic bill payment and presentment (EBPP), financial electronic data interchange (FEDI), electronic checks, direct deposit and direct payment.

Laws relating to ACH permit a draft (unsigned check) to be created for posting to a Debtor's account with a verbal authorization but will not allow recurring debits to be verbally authorized. Despite advances in electronic bill payment methods, current electronic bill collection systems and methods do not work because of several disconnects between the debtors and creditors including the availability of debtor's funds to the creditor.

Software programs are known in the art which facilitate the data gathering process between a Creditor and Debtor but are limited in that they provide little more than a data collection tool. A service representative (SR) of the Creditor must key in all the data they obtain from the Debtor. The Creditor must obtain the Debtor's bank name/ID, bank routing and transit number (RTN), and bank account number. The Creditor then prints the drafts drawn on Debtor's accounts, which have to be deposited by the Creditor into their corporate account and the payments have to be posted to the Debtor's account by keying the payments into the Creditor's loan system or via their lock box. Lock boxes are post office boxes that Debtors may send payments to and that a Bank collects and then processes for deposit into the Creditor's designated account.

Several deficiencies exist with this method of bill collection. The Creditor has to take their time gathering data from the Debtor. Also, if data is keyed in using manual input forms, these must be eventually transcribed to a computer system. This results in twice the work and double the possibility for error.

The Creditor must print and deposit drafts and keep such drafts at the Creditor's premises. This poses a significant security hazard for the Creditor.

The Creditor must print and mail notices to the customer summarizing the transaction or implement telephone recording equipment to record the verbal authorization.

The Creditor must post the payments from their system or lockbox to their accounting system.

The Creditor incurs greater costs in the processing of exception items such as when debtors forget to include payment coupons with their loan number information, forget to sign checks, and other exception handling issues.

Draft payments, like checks, can take up to two weeks to process if they are returned for non-sufficient funds (NSF). During this period of time, the Creditor does not know whether the payment was or was not good.

When drafts are used, the Debtor does not know when the withdrawal will come out of their account.

Pre-existing automated clearinghouse (ACH) debit products typically require the Creditor to keep a corporate account at the Originating Depository Financial Institution (ODFI) for the ACH debit. Creditors do not like having to maintain additional bank accounts.

Pre-existing programs may be set up to individually debit the Creditor's bank account when returned debits come back. All of the returned payments must be reversed in their loan system and these entries must be reconciled to the Creditor's bank account.

Tasking the Creditor's collections staff with obtaining the customer's banking information is inefficient for the Creditor because its collectors are specially trained and must spend time dealing with delinquent Debtors rather than processing payment transactions.

Finally, most Creditors are focusing on their core competencies of making loans and getting those loans repaid in the best way possible. Therefore, setting up an internal Call Center, specifically for the purpose of processing payment transactions, is not appealing to them.

Accordingly, it may be appreciated that there continues to be a need, in the bill collection industry, for a new and improved system and method for bill collections.

### SUMMARY OF THE INVENTION

This invention solves the difficulties described above when a Creditor wishes to collect money from a Debtor by providing a system and method to facilitate and streamline the payment of accounts (both current and delinquent) using ACH debits. This method and system allows a Creditor to operate more efficiently. It preserves good relations between Creditors and Debtors due to the increase in accounts paid resulting from the convenience of the system and method. Finally, Debtors are saved the difficulty of mailing (slow) or Express Mailing (expensive) a check to the Creditor to prevent or cure a delinquency.

One embodiment of the invention includes a turnkey method and system of bill collection. This method of payment collection utilizes an electronic system and comprises the steps of establishing a relationship between a Payment Processing Center and a Financial Institution. This relationship establishing step may include the situation where the Payment Processing Center is already part of or is itself the required financial institution. Next, a relationship may be established between the Payment Processing Center and a Creditor. Once the relationship is established, the Payment Processing Center and the Creditor must mutually determine and agree upon a format for the exchange and sending of data that seamlessly integrates with the Creditor's accounting systems. Next the method and system will assist the Creditor who has contacted a delinquent debtor via telephone to transfer the Debtor to the Payment Processing Center. The system and method will also assist the Creditor in transferring account information belonging to the Debtor to the Payment Processing Center. The method and system then assists the Payment Processing Center in the collection of payment information from the Debtor. Once this information is collected, the method and system assists the Payment Processing Center in processing a payment against the Debtor through the Financial Institution with which the Payment Processing Center is affiliated. The method and system then assists the Payment Processing Center in transferring payment to a Creditor account and sending payment information to Creditor's accounting system according to the previously determined exchange format.

Another embodiment of the invention includes an integration method and system for Creditors which do not wish to delegate the information-gathering portion of the payment collection process. This method of payment collection utilizes an electronic system and comprises the steps of establishing a relationship between a Payment Processing Center and a Financial Institution; establishing a relationship between the Payment Processing Center and a Creditor; and determining a format for the exchange and sending of data that seamlessly integrates with the Creditor's accounting systems. Then the method and system assists the Creditor in collecting payment information from the debtor. Once this information is collected, the method and system assists the Creditor in transferring debtor account information and debtor payment information to the Payment Processing Center. The method and system then assists the Payment Processing Center to process a payment against the Debtor through their affiliated financial institution. Then, the method and system assists the Payment Processing Center to transfer payment to a Creditor account and to send payment information to Creditor's accounting system. The Creditor's accounting system may include accounting systems, loan systems, accounts receivable systems, collections systems, debt processing systems and/or other forms of financial processing systems.

In one embodiment, the invention comprises a method of payment collection utilizing a computerized system comprising the steps of establishing a relationship between a Debtor, a Payment Processing Center, and a Creditor; determining a data exchange format and a data sending format that integrates with an accounting system managed by the Creditor; transferring an account information file of the Debtor from the Creditor to the Payment Processing Center according to said data exchange format; completing a payment information file for the Debtor; processing a payment against the Debtor in favor of the Creditor; depositing said payment in an intermediate bank account; transferring said payment from said intermediate bank account to a bank account associated with the Creditor; and sending a payment information file to said Creditor's accounting system according to said data sending format from the Payment Processing Center.

In another embodiment, the invention comprises a method of payment collection utilizing a computerized system comprising the steps of establishing a relationship between a Debtor, a Payment Processing Center, and a Creditor; determining a data exchange format and a data sending format that integrates with an accounting system managed by the Creditor; transferring an account information file and a payment information file associated with the Debtor from the Creditor to the Payment Processing Center according to said data exchange format; processing a payment against the Debtor in favor of the Creditor; depositing said payment in an intermediate bank account; transferring said payment from said intermediate bank account to a bank account associated with the Creditor; and sending a payment information file to said Creditor's accounting system according to said data sending format from the Payment Processing Center.

In another embodiment, the invention comprises A method of payment collection utilizing a computerized system comprising the steps of establishing a relationship between a Debtor, Creditor, and a Payment Processing Center, wherein said Payment Processing Center is an originating depository financial institution (ODFI) or capable of acting as an ODFI under rules promulgated by NACHA or a similar organization; determining a data exchange format and a data sending format that integrates with an accounting system managed by the Creditor; transferring an account information file of the Debtor from the Creditor to the Payment Processing Center according to said data exchange format; completing a payment information file for the Debtor; processing a payment against said Debtor through said Payment Processing Center; depositing said payment in an intermediate bank account; transferring said payment from said intermediate bank account to a bank account associated with the Creditor via an Automated Clearing House (ACH) Credit; and sending a payment information file from the Payment Processing Center to said Creditor's accounting system according to said data sending format.

In another embodiment, the invention comprises a method of payment collection utilizing a computerized system comprising the steps of establishing a relationship between a Debtor, Creditor, and a Payment Processing Center, wherein said Payment Processing Center is an originating depository financial institution (ODFI) or capable of acting as an ODFI under rules promulgated by NACHA or a similar organization; determining a data exchange format and a data sending format that integrates with a lockbox associated with the Creditor; transferring at least one item of information associated with an account associated with said Debtor from the Creditor to the Payment Processing Center; completing a payment information file for the Debtor; processing a payment against said Debtor through said Payment Processing Center; depositing said payment in an intermediate bank account; transferring said payment from said intermediate account to a bank account associated with the Creditor; and sending a payment information file from the Payment Processing Center to the lockbox according to said data sending format. A method of payment collection utilizing a computerized system comprising the steps of establishing a relationship between a Debtor, Creditor, and a Payment Processing Center, wherein said Payment Processing Center is an originating depository financial institution (ODFI) or capable of acting as an ODFI under rules promulgated by NACHA or a similar organization; determining a data exchange format and a data sending format that integrates with an accounting system managed by the Creditor; setting a profile for governing transactions according to said Creditor's preferences wherein said preferences include one or more of the following: a maximum number of transactions from a particular Debtor, a maximum debit amount, and a flag to indicate whether a non-sufficient funds return should be re-presented; transferring an account information file and a partially completed payment information file associated with said Debtor from the Creditor to the Payment Processing Center according to said data exchange format; completing said partially-completed payment information file for the Debtor; processing a payment against said Debtor through said Payment Processing Center via an Automated Clearing House (ACH) debit; depositing said payment in an intermediate bank account; transferring said payment from said intermediate bank account to a bank account associated with the Creditor via an Automated Clearing House (ACH) Credit; and sending a payment information file from the Payment Processing Center to said Creditor's accounting system according to said data sending format.

In another embodiment, the invention comprises a method of payment collection utilizing a computerized system comprising the steps of establishing a relationship between a Debtor, Creditor, and a Payment Processing Center, wherein said Payment Processing Center is an originating depository financial institution (ODFI) or capable of acting as an ODFI under rules promulgated by NACHA or a similar organization; determining a data exchange format and a data sending format that integrates with an accounting system associated with the Creditor; transferring an account information file of the Debtor from the Creditor to the Payment Processing Center according to said data exchange format; completing a payment information file for the Debtor; testing said payment information file by submitting a zero dollar debit against a bank account associated with the Debtor; processing a payment against said Debtor through said Payment Processing Center via an Automated Clearing House (ACH) debit; depositing said payment in an intermediate bank account; transferring said payment from said intermediate bank account to a bank account associated with the Creditor via an Automated Clearing House (ACH) Credit; and sending a payment information file from the Payment Processing Center to said Creditor's accounting system according to said data sending format.

In another embodiment, the invention comprises a method of payment collection utilizing a computerized system comprising the steps of establishing a relationship between a Debtor, Creditor, and a Payment Processing Center, wherein said Payment Processing Center is an originating depository financial institution (ODFI) or capable of acting as an ODFI under rules promulgated by NACHA or a similar organization; determining a data exchange format and a data sending format that integrates with an accounting system managed by the Creditor; transferring an account information file of the Debtor from the Creditor to the Payment Processing Center according to said data exchange format; completing a payment information file for the Debtor; processing a payment against said Debtor through said Payment Processing Center via an Automated Clearing House (ACH) debit; depositing a series of payments for a particular Creditor in a custodial bank account earmarked for said particular Creditor until a predetermined amount or time is fulfilled; transferring said payments from said custodial bank account to a bank account associated with the Creditor when said predetermined amount or time has been fulfilled; and sending a payment information file from the Payment Processing Center to said Creditor's accounting system according to said data sending format.

In another embodiment, the invention comprises a method of payment collection utilizing a computerized system comprising the steps of establishing a relationship between a Debtor, Creditor, and a Payment Processing Center, wherein said Payment Processing Center is an originating depository financial institution (ODFI) or capable of acting as an ODFI under rules promulgated by NACHA or a similar organization; determining a data exchange format and a data sending format that integrates with an accounting system managed by the Creditor; transferring an account information file of the Debtor from the Creditor to the Payment Processing Center according to said data exchange format; completing a payment information file for the Debtor; processing a payment against said Debtor through said Payment Processing Center via an Automated Clearing House (ACH) debit; depositing said payment in an intermediate bank account; transferring said payment from said intermediate bank account to a bank account associated with the Creditor via an Automated Clearing House (ACH) debit; sending a payment information file from the Payment Processing Center to said Creditor's accounting system according to said data sending format; if said payment is denied by a bank associated with said Debtor, entering a debit in said intermediate bank account until a Creditor associated with said payment is identified; once said Creditor associated with said payment is identified, providing a notification to said Creditor indicating that a denial occurred wherein said notification further includes a reason for said denial; sending a reversal information file from the Payment Processing Center to said Creditor's accounting system according to said data sending format; initiating an ACH debit against a bank account associated with said Creditor; crediting said intermediate bank account with said amount debited from said Creditor's bank account.

In another embodiment, the invention comprises a method of payment collection utilizing a computerized system comprising the steps of establishing a relationship between a Debtor, Creditor, and a Payment Processing Center, wherein said Payment Processing Center is an originating depository financial institution (ODFI) or capable of acting as an ODFI under rules promulgated by NACHA or a similar organization; determining a data exchange format and a data sending format that integrates with an accounting system managed by the Creditor; transferring an account information file of the Debtor from the Creditor to the Payment Processing Center according to said data exchange format wherein said account information file includes an account number associated with the Debtor, a name associated with the Debtor, a social security number associated with the Debtor, and a payment amount associated with the Debtor, and an identification code associated with the Creditor; completing a payment information file for the Debtor; processing a payment against said Debtor through said Payment Processing Center; depositing said payment in an intermediate bank account; transferring said payment from said intermediate bank account to a bank account associated with the Creditor via an Automated Clearing House (ACH) Credit; and sending a payment information file from the Payment Processing Center to said Creditor's accounting system according to said data sending format.

In another embodiment, the invention comprises a method of payment collection utilizing a computerized system comprising the steps of establishing a relationship between a Debtor, a Payment Processing Center, and a Creditor; determining a data exchange format and a data sending format that integrates with an accounting system managed by the Creditor; transferring an account information file of the Debtor from the Creditor to the Payment Processing Center according to said data exchange format wherein said account information file includes a payment date associated with a recurring payment obligation of the Debtor; completing a payment information file for the Debtor; storing said account information file and said payment information file in a database associated with said Payment Processing Center; processing a payment against the Debtor in favor of the Creditor; depositing said payment in an intermediate bank account; transferring said payment from said intermediate bank account to a bank account associated with the Creditor; sending a payment information file to said Creditor's accounting system according to said data sending format from the Payment Processing Center; scanning said database for said payment date associated with said recurring payment obligation; if a current date is less than a predetermined time period prior to said payment date, sending a reminder to said Debtor of said payment date prior to said Debtor; providing a website comprising a payment processing form to said Debtor; if said Debtor utilizes said payment processing form on said website, storing at least one element of said payment processing form in a cookie; and if said Debtor utilizes said payment processing form on said website a second time, presenting said payment processing form with said at least one element saved in said cookie.

In another embodiment, the invention comprises a method of payment collection utilizing a computerized system comprising the steps of establishing a relationship between a Debtor, a Payment Processing Center, and a Creditor; determining a data exchange format and a data sending format that integrates with an accounting system managed by the Creditor; transferring an account information file of the Debtor from the Creditor to the Payment Processing Center according to said data exchange format; completing a payment information file for the Debtor wherein said payment information file includes a contact profile associated with said Debtor; processing a payment against the Debtor in favor of the Creditor; if a payment request associated with said payment receives a denial from a bank associated with said Debtor, contacting said Debtor and determining a reason for said denial; addressing said reason for said denial; re-processing said payment against the Debtor in favor of the Creditor; depositing said payment in an intermediate bank account; transferring said payment from said intermediate bank account to a bank account associated with the Creditor; and sending a payment information file to said Creditor's accounting system according to said data sending format from the Payment Processing Center.

In another embodiment, the invention comprises a method of payment collection utilizing a computerized system comprising the steps of establishing a relationship between a Debtor, Creditor, and a Payment Processing Center, wherein said Payment Processing Center is an originating depository financial institution (ODFI) or capable of acting as an ODFI under rules promulgated by NACHA or a similar organization and wherein said Payment Processing Center comprises a call center; determining a data exchange format and a data sending format that integrates with an accounting system managed by the Creditor; transferring an account information file of the Debtor from the Creditor to the Payment Processing Center according to said data exchange format; completing a payment information file for the Debtor; processing a payment against said Debtor through said Payment Processing Center; depositing said payment in an intermediate bank account; transferring said payment from said intermediate bank account to a bank account associated with the Creditor via an Automated Clearing House (ACH) Credit; and sending a payment information file from the Payment Processing Center to said Creditor's accounting system according to said data sending format.

### BRIEF DESCRIPTION OF THE DRAWINGS

The accompanying drawings incorporated in and forming part of the specification illustrate several aspects of the present invention. In the drawings:

FIG. 1-2 illustrate a flowchart of one embodiment of the system and method.

FIG. 3 illustrates an example file structure used to store and exchange data between the Call Center and the Creditor.

FIG. 4 depicts Event Codes and Event Desciptions sent and received by the Payment Processing Center.

FIG. 5 depicts Stop Codes sent and received by the Payment Processing Center.

FIG. 6 depicts Error Messages sent by the Payment Processing Center to the Creditor.

For the purpose of promoting an understanding of the principles of the invention, reference will now be made in detail to the present preferred embodiment to the invention, examples of which are illustrated in the accompanying drawings and specific language will be used to describe the same. It will nevertheless be understood that no limitation of the scope of the invention is thereby intended toward such alterations and further modifications in the illustrated device and such further applications of the principles of the invention as illustrated therein as would normally occur to one skilled in the art to which the invention relates.

### DETAILED DESCRIPTION OF SEVERAL EMBODIMENTS OF THE INVENTION

The invention provides a method for enhancing bill collection utilizing electronic funds transfer by outsourcing the bill collection to an external entity that is either a financial institution or affiliated with a financial institution. Using known programming techniques, a system employing the method disclosed in this application facilitates the payment and sending process by ACH debit (other methods of payment may also be incorporated into the system) from the Debtor's account and then sending a file to allow a Creditor to update their accounts accordingly. This may be applied to one-time only payments or recurring payments. Recurring debits may be set up according to a schedule specified by the Debtor. The system seamlessly integrates with the Creditor's legacy systems to provide accurate and fast data to allow a Creditor to update those legacy systems after a payment has been processed.

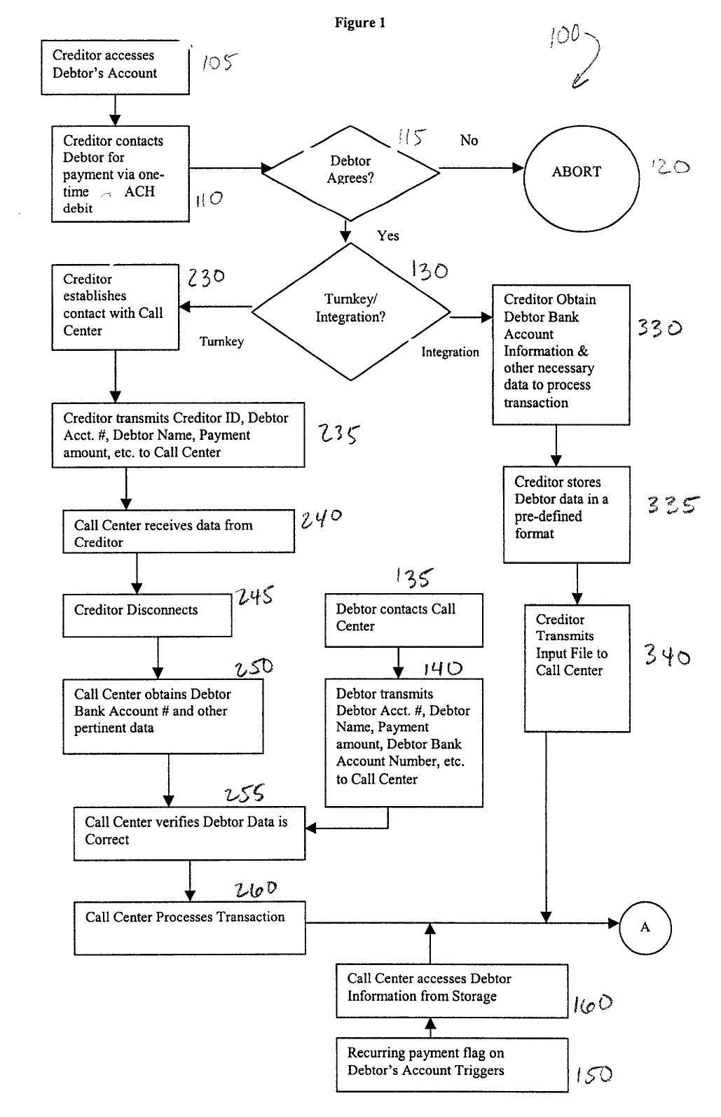

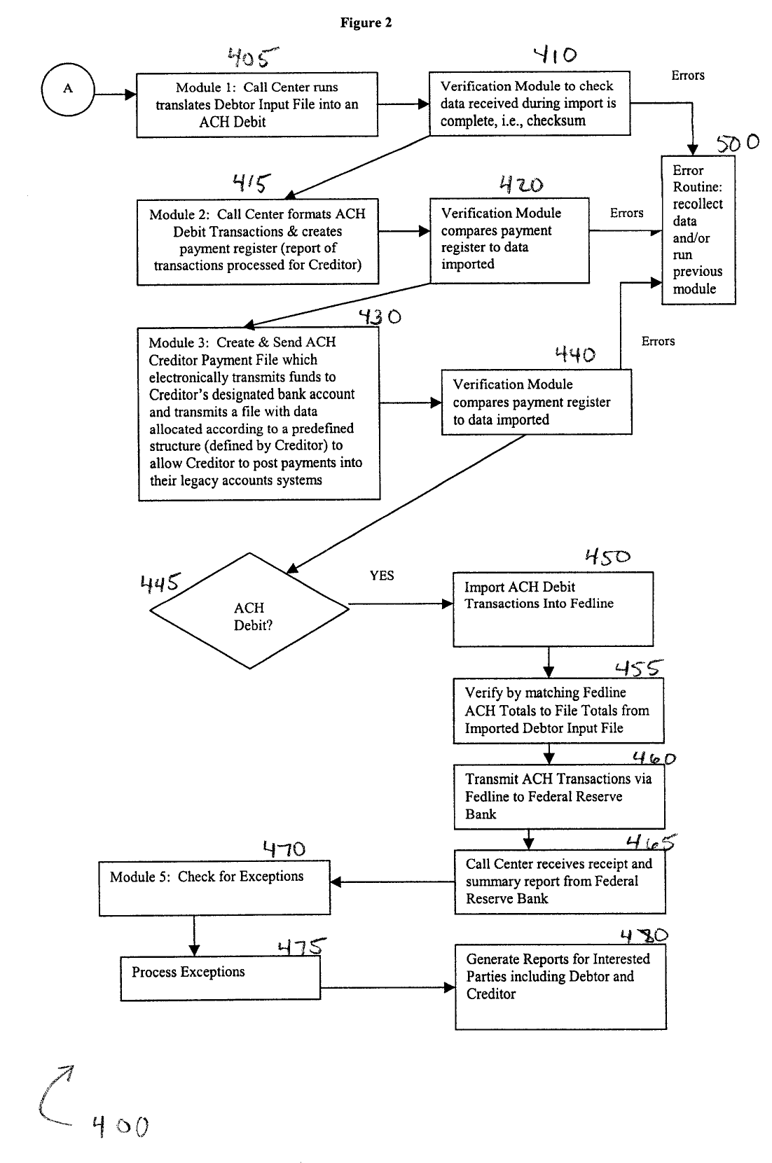

Referring generally to FIGS. 1 and 2, the system (100, 400) and method envisions at least two embodiments. In one embodiment, a turnkey system (230) and method is provided which externalizes nearly the entire bill collection procedure and creates and sends the data to update the Creditor's accounts. A second embodiment provides an integration component (330) which allows the Creditor to collect data from a Debtor which is formatted into a predefined file and (335) then sends that file to the Payment Processing Center so that the Payment Processing Center (340) may process the transaction as well as create and send data to update the Creditor's accounts. The integration component suits Creditors that prefer to be the sole contact with the customer, and do not want the turnkey alternative.

Turnkey Embodiment

In one embodiment, contact is established between a Creditor and a Debtor (110). The Creditor's employee (usually a collector) requests authorization to debit a payment (this request should include the payment amount and terms relating to the payment). If the Debtor agrees (this authorization may be recorded) (115), the Creditor transfers the Debtor to an external Payment Processing Center staffed with Payment Processing Representatives (the Payment Processing Center may also be entirely automated) (230). The Creditor may also provide the Debtor with a phone number, e-mail address, or uniform resource locator link to contact the Payment Processing Center rather than directly connect the Debtor to the Payment Processing Center (135).

The Creditor may provide the Payment Processing Center with information about the Debtor's account (i.e., loan number, Debtor's name, Debtor's social security number, and the payment amount) (235). Creditor will also give the Payment Processing Center its own ID number to identify the originator of the transaction. This exchange of information may be automated, for instance, a file containing this information may be sent over the network simultaneously with the connection to seamlessly integrate the exchange of information. If the Debtor has utilized the system and method previously, the Payment Processing Center may also access the Debtor's account via their own systems and databases (160). Once the Payment Processing Representative takes control of the transaction, the Creditor may disconnect (245) and contact another delinquent borrower.

If permission is not granted, the transaction is aborted and the Payment Processing Center will notify the Creditor of the abort (120).

If permission is granted, the Payment Processing Center will obtain the necessary information to effect payment of the debt such as Debtor's bank's routing number (RTN), and debtor's bank account number (250). A graphical user interface may be employed to facilitate the information gathering process. From the RTN, Payment Processing Center may pull the bank name and address from a purchased database and into the input screen and confirms them with the debtor. If the RTN is not in the database, the Debtor is asked to verify the RTN again. This prevents the transaction from rejecting due to erroneous information. The Payment Processing Center may also obtain Debtor's zip code and automatically generate city and state from said zip code. The Payment Processing Center may obtain Debtor's address. When all the pertinent information has been collected, the Payment Processing Center will confirm all material information with Debtor (255). This information may be stored into a file or a database.

The Payment Processing Center will produce an ACH debit in the amount agreed upon between Creditor and Debtor. A handling fee may be added to the debit. The Payment Processing Center will tell Debtor to notate the debit in their register. The Debtor may cancel the transaction at any point during the process.

The Payment Processing Representatives will then process the debit (260). ACH debits permit a very quick turnaround in determining whether a non-sufficient funds exception will occur because the Payment Processing Representatives either are part of or are directly affiliated with a bank that can process the transaction very quickly, and the ACH rules mandate a two day window that a bank must return items to the Originator, or else they will not be accepted. Returned transactions may also be reprocessed by the Payment Processing Center, just like a check can be re-presented to the payee's bank. This is beneficial when there is merely a timing issue with the time a deposit posts (i.e. payroll) and when the debit is posted. Due to the return rules, these reprocessed debits can be accomplished with very little time lag.

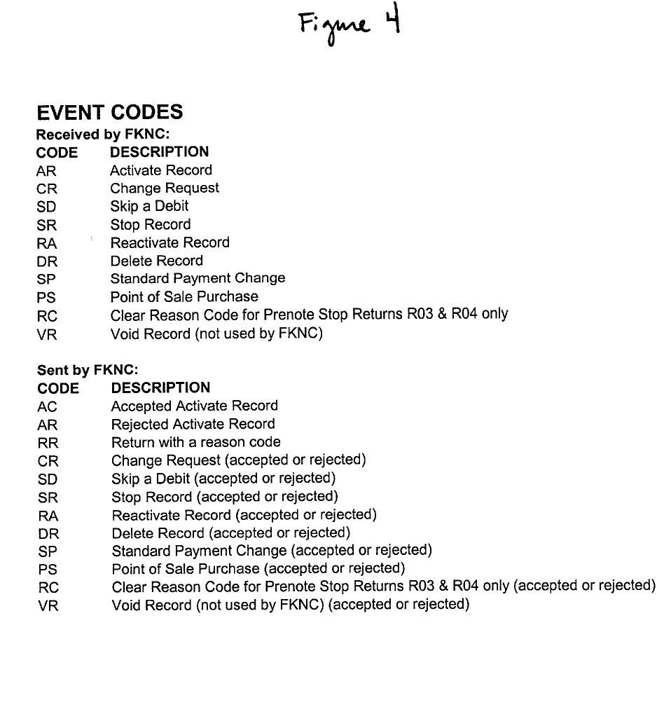

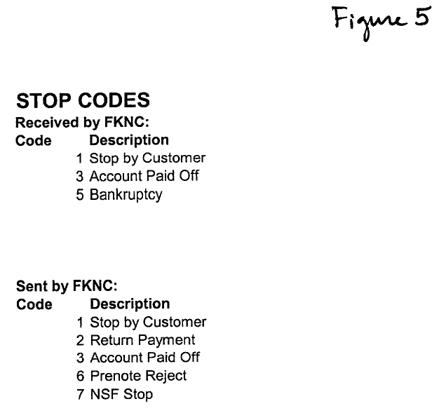

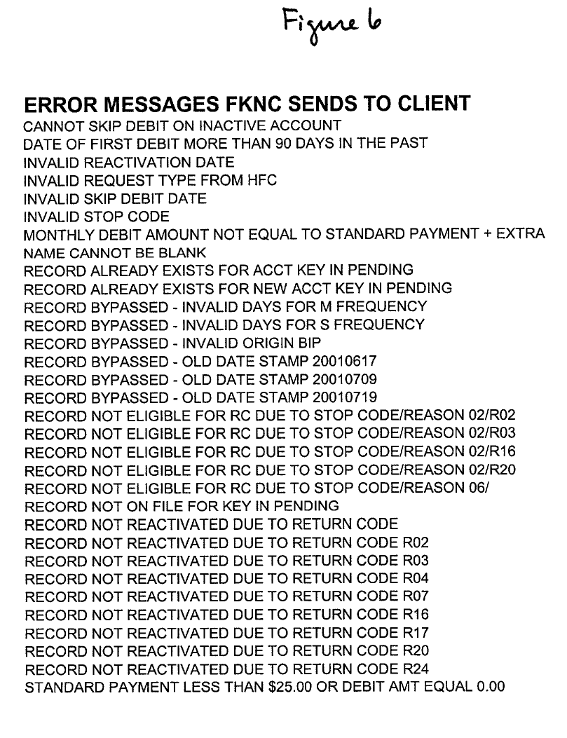

Referring to FIG. 2, where a debit is generated, the Payment Processing Center will deposit the payment for the benefit of Creditor in an insured depository account at the Payment Processing Center's affiliate bank (405). This depository account is then debited and the funds for the debit are sent to the Creditor via ACH credit (430). If ACH debits are used to make the payment from the Debtor's account, an offsetting ACH credit is generated to the Creditor's corporate bank account. Payment Processing Center and Creditor will have previously established a cut-off time for transactions to be processed on the current business day. The Payment Processing Center will take calls after the cutoff time, but the transactions will be sent on the following business day. The Payment Processing Center will deposit to Creditor's corporate bank account via ACH credit, each predefined period, an amount that represents the aggregate amount of drafts payable to Creditor or ACH debits, processed before the cutoff time, and for which payment has not been previously sent, less Payment Processing Center's service fee. This deposit will be posted to the Creditor's account by their Bank as of open of business the following business day. If debit is returned to the Payment Processing Center's affiliated Bank for NSF, because Debtor's checking account was closed; Debtor's account number is incorrect; or Debtor cancels transaction (before or after completion), Payment Processing Center will notify Creditor electronically or through a method acceptable to Creditor of the Debtor's name and account number with Creditor, and the amount of the returned/cancelled debit (see generally, FIGS. 4-6). Since the Bank has already paid, and Creditor has already received the amount due; therefore, the Payment Processing Center will then electronically deduct the amount Creditor received via an ACH debit to the Creditor's corporate bank account, which will be posted to the Creditor's account by their bank as of open of business the following business day. See infra Back-End Processing.

The Payment Processing Center sends a confirmation notice to Debtor containing the date the Debtor authorized production of the debit, the name of the bank on which the debit is drawn, the amount of the debit, the Debtor's account number with the Creditor, and a Creditor telephone number that the Debtor can call with questions. As an alternative, the Payment Processing Center may record the Debtor's verbal authorization and mail a notice to the Debtor either automatically or upon request. The Payment Processing Center will generate reports to Creditor of collections processed each pre-determined time period.

The Payment Processing Center may set up recurring debits, should the Debtor desire that feature. If the Debtor is receptive, an Authorization to Debit Account form is sent (via fax, mail, e-mail, etc.) to the Debtor to complete, sign, and then fax or mail to the Payment Processing Center.

Back-end Processing

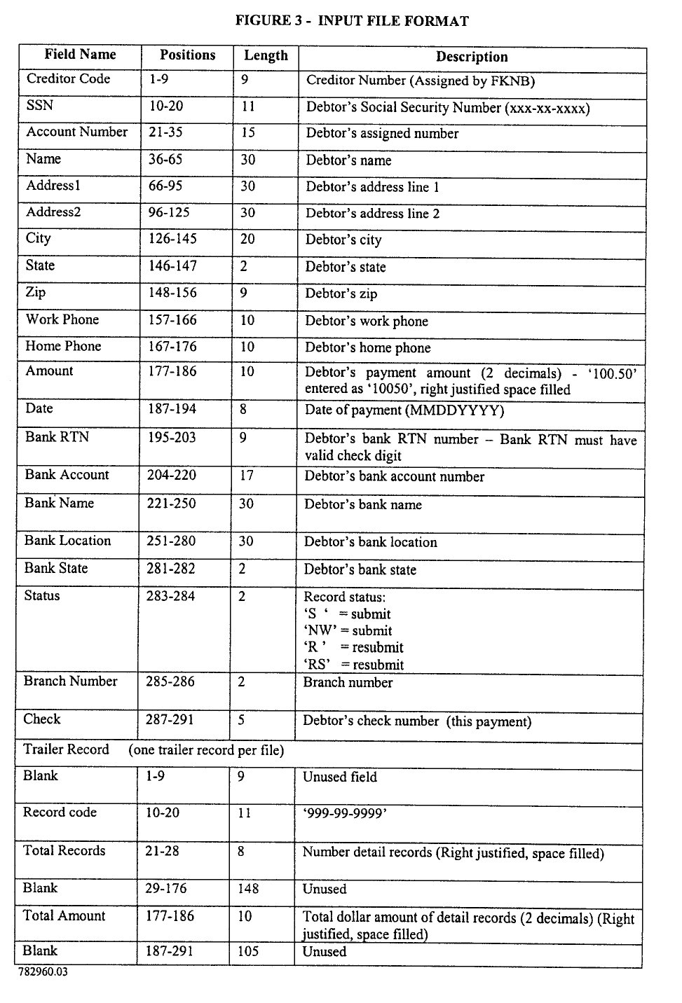

The Payment Processing Representatives will deposit the payment in a clearing account set up for the Creditor at the Payment Processing Representative's affiliated Bank. This eliminates the need for Creditors to maintain corporate accounts at the bank that is the originating depository financial institution (ODFI) for the ACH debit as required by the prior art. Rather, funds may be sent to any corporate account at any bank designated by the Creditor. The Payment Processing Representatives electronically transfer that deposit to a financial institution designated by the Creditor. In the case of debit payments, an ACH credit is originated in an amount equal to the payment debit to send the funds to the Creditor. The Payment Processing Representatives send the Creditor the information necessary to allow the Creditor to post the payment to their system in a file format (FIG. 3) that allows the posting data to be easily and accurately transferred between the Payment Processing Center's systems and the Creditor's account systems. This file format (FIG. 3) may be defined by the Creditor or the Payment Processing Center. This helps reduce or eliminate lock box fees and internal payment processing center costs. The Payment Processing Representatives may optionally send a receipt to the Debtor.

The service is customized to integrate with Creditor's systems so that payments and reversals are transmitted to Creditor's loan systems without manual handling. Reporting can also be customized to meet the Creditor's needs. Depending on the situation, as well as the Creditor's needs, the system or method effects the Debtor's payment by an ACH debit that deducts the funds electronically from the Debtor's bank account. These functions may be accomplished in a batch process.

The Payment Processing Center exports to the internal computer network the file for a predefined period's ACH debits. A report listing the totals for the file is compared the data imported to the Payment Processing Center, to verify the completeness of the file imported into the Payment Processing Center (410). Known programming techniques, such as checksums, may also be utilized to verify file integrity.

The Payment Processing Center generates individual Creditor payment registers with totals and verifies the information back to Debits Export File totals. Creditor payment registers contain such information as the Creditor Name, the Debtor Account Number, Debtor Name, Debtor's Bank Routing Number, Name of Debtor's Bank, the Debtor's Check Number, and the Total Amount approved for payment. The Payment Register further includes the total number of debits (less any rejected) and the total amount approved for payment (less any rejected payments).

Debit Procedures

If the payment from the Debtor's account is made via ACH debit, a program creates a NACHA formatted ACH debit file and the ACH credit payments to the Creditor for those debits. A program creates the ACH credit to deposit the payments into the Creditor's designated corporate bank account and also may incorporate the media transmitted to the Creditor within the ACH record using, for example, a standard format such as Financial Electronic Data Interchange or other means specifically requested by the Creditor. Funds are sent from this bank account to the Creditor's corporate bank account via ACH credit or bank wire and the payment posting data may be sent including electronically, via FTP, EDI, VPN or equivalent technology.

A list of all daily debits (Register) for a particular Creditor, a breakdown of debits, returns, and fees (ACH Total Verification Report), a Return Registers Report, and a batch summary of the total debits/credits are sent to the Creditor. The Register includes information such as the Creditor's ID, the Debtor's name, the Debtor's bank routing number, Debtor's bank account number, the date the debit was processed, and the amount. The Return Register Report includes the Creditor's ID, Creditor's account number, date of the debit, Debtor's bank routing number, Debtor's bank account number, Debtor's name, a comment regarding the reason for the return, and the amount returned.

Where payments are made using ACH debits, the NACHA formatted files of debits and credits are loaded into a computer containing Fedline software which allows a financial institution access to the Federal Reserve Banking System (Fed) which serves as the ACH Operator (450). A verification process may be run (455). The ACH debits file is imported into the Fedline software and a NACHA formatted file is created to be transmitted to the Fed or another ACH Operator, and total debits and credits displayed by the Fedline are verified against the data imported into the Payment Processing Center (460). Once the ACH file is received by the Fed and processed without error, an acknowledgment of the file is sent back to the Payment Processing Center and logged (465).

The Payment Processing Center may print out and mail to the Debtor a notice confirming their authorization for the creditor to debit their account for the specified payment on the specified day and the fee charged. Total number of notices printed is displayed on the system screen, and is verified back to number of debits entered for that day, obtained by adding up the total items from all payment registers printed for the day, to assure that there was not a problem in printing and a notice was printed for each Debtor. If there is a problem with the printer (such as a jam), the system will go back and reprint the last two notices before the jam. Any duplicate notices are then pulled prior to mailing. The Payment Processing Center may record the Debtor's verbal authorization and mail a notice to the Debtor either automatically or upon request.

Integration Embodiment

In one version of the integration embodiment, the Creditor has its own graphical user interface for collecting Debtor information. (330) This information is saved to a file (335) that is sent to the Payment Processing Center for processing (340). The Payment Processing Center processes the ACH debit (260) and then sends payments electronically back to the Creditor or, if the payment does not process correctly, notification of the error.

The key feature of this system and method is the seamless interfaces between the Payment Processing Center as the transaction processor, and the Creditor as the transaction originator. The information for the transactions is captured at the Creditor using known programming techniques designed to create file input into the Payment Processing Center systems. The output from the Payment Processing Center goes to the Creditor to post payments, status information on accounts, and all reports are sent back to the Creditor via files that are uploaded into their various systems. Another unique feature is that Payment Processing Center will process the payments on the starting dates and the frequency the Debtor wants—it is completely flexible to accommodate monthly, bimonthly, and weekly pay schedules.

In another embodiment, the Payment Processing Center may obtain the Debtor's contact information, i.e., e-mail address. Then, if an exception occurs while processing the ACH debit, the Payment Processing Center may notify the Debtor and engage in a process to determine the error and fix it. The Payment Processing Center may then retransact the process. If the transaction has been successfully completed, a receipt indicating such may be sent to the Debtor.

In yet another embodiment, the system may be set up to operate proactively. Debtor accounts stored in databases at the Payment Processing Center may be flagged for recurring debits so those debits will be automatically processed by the system (150). Or, where Debtor has only authorized a one-time debit, the Payment Processing Center may contact and remind the Debtor of a potential “date due” shortly before payment is due. The reminder may include a link to a website where the Debtor can enter the necessary information to process the transaction. After the customer makes their first payment via the system and method, the information will be stored in a database or in cookies so it can be presented to the Debtor the next time a payment is processed further reducing the time involved in transacting such business.

The system may also be set up to handle variable accounts such as revolving loans, adjustable interest rates or credit card accounts. The Payment Processing Center database may be set up to communicate with the legacy systems to exchange this type of information as well as status information regarding a Debtor's account.

In another embodiment, the Creditor may simply pass transactions/debtor files to the Payment Processing Center, and the Payment Processing Center does not have contact with the Debtor. The Creditor handles the entire relationship with the debtor and the Payment Processing Center may handle the entire collection by the process disclosed above.

Debtors benefit by receiving verification that the payment has been made. Creditors achieve many benefits from this system including saving time in dealing with delinquent debtors, avoiding writing/endorsing/depositing drafts, and eliminating the time lag normally associated with processing a payment by a delinquent debtor. Recovery procedures are also available if, for some reason, the payment is returned by the Debtor's bank, i.e., due to not sufficient funds (NSF), wrong account numbers, etc. The reversal and reconciliation of returned payments is facilitated by creating a posting file in the format required by the Creditor to reverse payments off of their system. Then, funds to cover returns are withdrawn from the Creditor's corporate account via ACH debit and/or a bank wire is sent by the Creditor. Thus, the Creditor does not have to deal with reconciliation challenges created by ACH returns because the returns are posted to accounts reconciled by the Payment Processing Center. There is some risk that the ACH debit drawn on the corporate account will be returned for insufficient funds, however, an analysis of a Creditor's financial strength should minimize this risk. In most pre-existing ACH programs, the bank processing the ACH (Originating Bank) requires the Creditor to maintain a corporate banking relationship. In this model, when debits are returned as unpaid, they are often individually posted to the Creditor's corporate account, and they must use the limited information provided on the bank statement to research and reverse the payment from their loan system. With some returned debits being re-presented a second time, the reconciliation of these items through the corporate account is a time-consuming process. In this embodiment, the Payment Processing Center takes on that task, as well as provides electronic information to the Creditor's system to reverse the entry.

Reports may be generated at various stages of these processes detailing the transactions completed (480). These reports may then be sent to any interested parties. Several reports are generated at the close of the business day after all Creditor processing has been completed and the phones logged off for the day. The Debit Report shows the individual and total number of debits, by Creditor's branch identification numbers, that were sent, imported, rejected, debited, returned, and returned for insufficient funds before a predetermined time. The Creditor Call Report prints out by Creditor's branch identification numbers and shows a breakdown by Creditor ID of the number of calls, aborts, and average length of each call. Each branch is faxed a copy of their report. The Creditor Call Report Recap shows a breakdown summary, by Creditor's branch identification numbers, of the number of calls that day and the minimum, maximum, and average call times. The Aborted Call Report Recap lists each Debtor's name, date of abort, account number, collection amount, reason for the abort, and Creditor's ID of calls that aborted that day. An individual report is created for each branch. There are also reports created for internal use only including: an Hourly Call Report, which shows a breakdown by hour of the number of calls and aborts, and the User Call Report, which shows a breakdown by user of number of calls, aborts, and length of call time. Both of these reports are produced and filed for internal reporting use only to determine the staffing requirements by hour and day for the Call Center to achieve the maximum answer rate, i.e., 100% answer rate demanded by the Creditor contracting for the service.

A Debtor change/edit could be made to a Debtor account only the same day the one time debit was processed and before the export. Should this occur the Payment Processing Center would abort the initial call and send an Aborted Call Report to the Creditor that transferred the call. These changes are filed with the aborted call reports.

If a Creditor has a change to be made in the system, the change is sent to the Payment Processing Center.

The system employing the method may be implemented over a variety of computer systems, using a variety of computer readable mediums, and over a variety of networked arrangements including bulletin boards and the Internet. The system may be utilized by Debtors and Creditors through a variety of mediums including the telephone, local area network, the Internet, and more. Various security measures may be employed to protect the integrity of the files transferred.

What is claimed:

1. A method of payment collection utilizing a computerized system comprising the steps of:
a. establishing a relationship between a Debtor, a Payment Processing Center, and a Creditor;
b. determining a data exchange format and a data sending format that integrates with an accounting system managed by the Creditor;
c. transferring an account information file of the Debtor from the Creditor to the Payment Processing Center according to said data exchange format;
d. completing a payment information file for the Debtor;
e. processing a payment against the Debtor in favor of the Creditor;
f. depositing said payment in an intermediate bank account;
g. transferring said payment from said intermediate bank account to a bank account associated with the Creditor; and
h. sending a payment information file to said Creditor's accounting system according to said data sending format from the Payment Processing Center.

2. A method of payment collection utilizing a computerized system comprising the steps of:
a. establishing a relationship between a Debtor, a Payment Processing Center, and a Creditor;
b. determining a data exchange format and a data sending format that integrates with an accounting system managed by the Creditor;
c. transferring an account information file and a payment information file associated with the Debtor from the Creditor to the Payment Processing Center according to said data exchange format;
d. processing a payment against the Debtor in favor of the Creditor;
e. depositing said payment in an intermediate bank account;
f. transferring said payment from said intermediate bank account to a bank account associated with the Creditor; and
g. sending a payment information file to said Creditor's accounting system according to said data sending format from the Payment Processing Center.

3. A method of payment collection utilizing a computerized system comprising the steps of:
a. establishing a relationship between a Debtor, Creditor, and a Payment Processing Center, wherein said Payment Processing Center is an originating depository financial institution (ODFI) or capable of acting as an ODFI under rules promulgated by NACHA or a similar organization;
b. determining a data exchange format and a data sending format that integrates with an accounting system managed by the Creditor;
c. transferring an account information file of the Debtor from the Creditor to the Payment Processing Center according to said data exchange format;
d. completing a payment information file for the Debtor;
e. processing a payment against said Debtor through said Payment Processing Center;
f. depositing said payment in an intermediate bank account;
g. transferring said payment from said intermediate bank account to a bank account associated with the Creditor via an Automated Clearing House (ACH) Credit; and
h. sending a payment information file from the Payment Processing Center to said Creditor's accounting system according to said data sending format.

4. A method of payment collection utilizing a computerized system comprising the steps of:
a. establishing a relationship between a Debtor, Creditor, and a Payment Processing Center, wherein said Payment Processing Center is an originating depository financial institution (ODFI) or capable of acting as an ODFI under rules promulgated by NACHA or a similar organization;
b. determining a data exchange format and a data sending format that integrates with a lockbox associated with the Creditor;
c. transferring at least one item of information associated with an account associated with said Debtor from the Creditor to the Payment Processing Center;
d. completing a payment information file for the Debtor;
e. processing a payment against said Debtor through said Payment Processing Center;
f. depositing said payment in an intermediate bank account;
g. transferring said payment from said intermediate account to a bank account associated with the Creditor; and
h. sending a payment information file from the Payment Processing Center to the lockbox according to said data sending format.

5. A method of payment collection utilizing a computerized system comprising the steps of:
a. establishing a relationship between a Debtor, Creditor, and a Payment Processing Center, wherein said Payment Processing Center is an originating depository financial institution (ODFI) or capable of acting as an ODFI under rules promulgated by NACHA or a similar organization;
b. determining a data exchange format and a data sending format that integrates with an accounting system managed by the Creditor;
c. setting a profile for governing transactions according to said Creditor's preferences wherein said preferences include one or more of the following: a maximum number of NSF returns from a particular Debtor, a maximum debit amount, and a flag to indicate whether a non-sufficient funds return should be re-presented;
d. transferring an account information file and a partially completed payment information file associated with said Debtor from the Creditor to the Payment Processing Center according to said data exchange format;
e. completing said partially-completed payment information file for the Debtor;
f. processing a payment against said Debtor through said Payment Processing Center via an Automated Clearing House (ACH) debit;
g. depositing said payment in an intermediate bank account;
h. transferring said payment from said intermediate bank account to a bank account associated with the Creditor via an Automated Clearing House (ACH) Credit; and
i. sending a payment information file from the Payment Processing Center to said Creditor's accounting system according to said data sending format.

6. A method of payment collection utilizing a computerized system comprising the steps of:
a. establishing a relationship between a Debtor, Creditor, and a Payment Processing Center, wherein said Payment Processing Center is an originating depository financial institution (ODFI) or capable of acting as an ODFI under rules promulgated by NACHA or a similar organization;
b. determining a data exchange format and a data sending format that integrates with an accounting system associated with the Creditor;
c. transferring an account information file of the Debtor from the Creditor to the Payment Processing Center according to said data exchange format;
d. completing a payment information file for the Debtor;
e. testing said payment information file by submitting a zero dollar debit against a bank account associated with the Debtor;
f. processing a payment against said Debtor through said Payment Processing Center via an Automated Clearing House (ACH) debit;
g. depositing said payment in an intermediate bank account;
h. transferring said payment from said intermediate bank account to a bank account associated with the Creditor via an Automated Clearing House (ACH) Credit; and
i. sending a payment information file from the Payment Processing Center to said Creditor's accounting system according to said data sending format.

7. A method of payment collection utilizing a computerized system comprising the steps of:
a. establishing a relationship between a Debtor, Creditor, and a Payment Processing Center, wherein said Payment Processing Center is an originating depository financial institution (ODFI) or capable of acting as an ODFI under rules promulgated by NACHA or a similar organization;
b. determining a data exchange format and a data sending format that integrates with an accounting system managed by the Creditor;
c. transferring an account information file of the Debtor from the Creditor to the Payment Processing Center according to said data exchange format;
d. completing a payment information file for the Debtor;
e. processing a payment against said Debtor through said Payment Processing Center via an Automated Clearing House (ACH) debit;
f. depositing a series of payments for a particular Creditor in a custodial bank account earmarked for said particular Creditor until a predetermined amount or time is fulfilled;
g. transferring said payments from said custodial bank account to a bank account associated with the Creditor when said predetermined amount or time has been fulfilled; and
h. sending a payment information file from the Payment Processing Center to said Creditor's accounting system according to said data sending format.

8. A method of payment collection utilizing a computerized system comprising the steps of:
a. establishing a relationship between a Debtor, Creditor, and a Payment Processing Center, wherein said Payment Processing Center is an originating depository financial institution (ODFI) or capable of acting as an ODFI under rules promulgated by NACHA or a similar organization;
b. determining a data exchange format and a data sending format that integrates with an accounting system managed by the Creditor;
c. transferring an account information file of the Debtor from the Creditor to the Payment Processing Center according to said data exchange format;
d. completing a payment information file for the Debtor;
e. processing a payment against said Debtor through said Payment Processing Center via an Automated Clearing House (ACH) debit;
f. depositing said payment in an intermediate bank account;
g. transferring said payment from said intermediate bank account to a bank account associated with the Creditor via an Automated Clearing House (ACH) debit;
h. sending a payment information file from the Payment Processing Center to said Creditor's accounting system according to said data sending format;
i. if said payment is denied by a bank associated with said Debtor, entering a debit in said intermediate bank account until a Creditor associated with said payment is identified;
j. once said Creditor associated with said payment is identified, providing a notification to said Creditor indicating that a denial occurred wherein said notification further includes a reason for said denial;
k. sending a reversal information file from the Payment Processing Center to said Creditor's accounting system according to said data sending format;
l. initiating an ACH debit against a bank account associated with said Creditor;
m. crediting said intermediate bank account with said amount debited from said Creditor's bank account.

9. A method of payment collection utilizing a computerized system comprising the steps of:
a. establishing a relationship between a Debtor, Creditor, and a Payment Processing Center, wherein said Payment Processing Center is an originating depository financial institution (ODFI) or capable of acting as an ODFI under rules promulgated by NACHA or a similar organization;
b. determining a data exchange format and a data sending format that integrates with an accounting system managed by the Creditor;
c. transferring an account information file of the Debtor from the Creditor to the Payment Processing Center according to said data exchange format wherein said account information file includes an account number associated with the Debtor, a name associated with the Debtor, a social security number associated with the Debtor, and a payment amount associated with the Debtor, and an identification code associated with the Creditor;
d. completing a payment information file for the Debtor;
e. processing a payment against said Debtor through said Payment Processing Center;
f. depositing said payment in an intermediate bank account;
g. transferring said payment from said intermediate bank account to a bank account associated with the Creditor via an Automated Clearing House (ACH) Credit; and
h. sending a payment information file from the Payment Processing Center to said Creditor's accounting system according to said data sending format.

10. A method of payment collection utilizing a computerized system comprising the steps of:
a. establishing a relationship between a Debtor, a Payment Processing Center, and a Creditor;
b. determining a data exchange format and a data sending format that integrates with an accounting system managed by the Creditor;
c. transferring an account information file of the Debtor from the Creditor to the Payment Processing Center according to said data exchange format wherein said account information file includes a payment date associated with a recurring payment obligation of the Debtor;
d. completing a payment information file for the Debtor;
e. storing said account information file and said payment information file in a database associated with said Payment Processing Center;
f. processing a payment against the Debtor in favor of the Creditor;
g. depositing said payment in an intermediate bank account;
h. transferring said payment from said intermediate bank account to a bank account associated with the Creditor;
i. sending a payment information file to said Creditor's accounting system according to said data sending format from the Payment Processing Center;
j. scanning said database for said payment date associated with said recurring payment obligation;
k. if a current date is less than a predetermined time period prior to said payment date, sending a reminder to said Debtor of said payment date prior to said Debtor;
l. providing a website comprising a payment processing form to said Debtor;
m. if said Debtor utilizes said payment processing form on said website, storing at least one element of said payment processing form in a cookie; and
n. if said Debtor utilizes said payment processing form on said website a second time, presenting said payment processing form with said at least one element saved in said cookie.

11. A method of payment collection utilizing a computerized system comprising the steps of:
a. establishing a relationship between a Debtor, a Payment Processing Center, and a Creditor;
b. determining a data exchange format and a data sending format that integrates with an accounting system managed by the Creditor;
c. transferring an account information file of the Debtor from the Creditor to the Payment Processing Center according to said data exchange format;
d. completing a payment information file for the Debtor wherein said payment information file includes a contact profile associated with said Debtor;
e. processing a payment against the Debtor in favor of the Creditor;
f. if a payment request associated with said payment receives a denial from a bank associated with said Debtor, contacting said Debtor and determining a reason for said denial;
g. addressing said reason for said denial;
h. re-processing said payment against the Debtor in favor of the Creditor;
i. depositing said payment in an intermediate bank account;
j. transferring said payment from said intermediate bank account to a bank account associated with the Creditor; and
k. sending a payment information file to said Creditor's accounting system according to said data sending format from the Payment Processing Center.

12. A method of payment collection utilizing a computerized system comprising the steps of:
a. establishing a relationship between a Debtor, Creditor, and a Payment Processing Center, wherein said Payment Processing Center is an originating depository financial institution (ODFI) or capable of acting as an ODFI under rules promulgated by NACHA or a similar organization and wherein said Payment Processing Center comprises a call center;
b. determining a data exchange format and a data sending format that integrates with an accounting system managed by the Creditor;
c. transferring an account information file of the Debtor from the Creditor to the Payment Processing Center according to said data exchange format;
d. completing a payment information file for the Debtor;
e. processing a payment against said Debtor through said Payment Processing Center;
f. depositing said payment in an intermediate bank account;
g. transferring said payment from said intermediate bank account to a bank account associated with the Creditor via an Automated Clearing House (ACH) Credit; and
h. sending a payment information file from the Payment Processing Center to said Creditor's accounting system according to said data sending format.
